(19) United States
(12) Patent Application Publication
(10) Pub. No.: US 2008/0114683 A1
(43) Pub. Date: May 15, 2008

(54) REMOTE TIME AND ATTENDANCE SYSTEM AND METHOD

(75) Inventors: Stephanie Neveu, Glendale, AZ (US); Gary Burleson, Glendale, AZ (US)

Correspondence Address: SNELL & WILMER L.L.P. (Main), 400 EAST VAN BUREN, ONE ARIZONA CENTER, PHOENIX, AZ, 85004-2202, US

(73) Assignee: NEVEU HOLDINGS, LLC, Glendale, AZ (US)

(21) Appl. No.: 11/940,139

(22) Filed: Nov. 14, 2007

Related U.S. Application Data
(60) Provisional application No. 60/865,781, filed on Nov. 14, 2006.

(51) Int. Cl. G06Q 10/00

(52) U.S. Cl. 705/50; 705/32

(57) ABSTRACT

A system and method for remote time collection are provided. Generally, various embodiments of the invention provide users with a system and method for tracking employee time and/or confirming job site arrival remotely. In accordance with various embodiments, a system and method for remote time collection comprises a variety of devices and components, such as a local client, a local server, a wireless communication system, and a remote computing device. An exemplary remote computing device comprises a biometric system and a GPS system for verifying that the correct employee is working at the correct job site.

### CROSS REFERENCE TO RELATED APPLICATIONS

This application claims priority to and the benefit of U.S. Provisional Application No. 60/865,781 entitled “METHOD AND SYSTEM FOR TIME COLLECTION AND OPERATIONS SCHEDULING” and filed on Nov. 14, 2006.

### FIELD OF INVENTION

The present invention relates to a time and attendance system and method, and in particular to a remote time and attendance system and method for collecting and tracking time and attendance.

### BACKGROUND OF THE INVENTION

One of the major issues with current time and attendance applications and systems is that there is no accountability for an individual who records their arrival or departure at a particular job site, i.e., by “clocking in” and “clocking out.” Some current systems allow individual workers to “clock in” and “clock out” for other co-workers, such that a company is not sure that a worker is actually present at a job site. Accordingly, a company might not be sure that a worker is present at the job site where that worker is supposed to be.

### SUMMARY OF THE INVENTION

A system and method for time collection and operations scheduling are provided. Generally, various embodiments of the invention provide users, e.g., companies, contractors, subcontractors, managers, supervisors, and the like, with a system and method for tracking employee time and/or confirming job site arrival remotely. In accordance with various embodiments, a system and method for remote time collection comprises a variety of devices and components, such as a local client, a local server, a wireless communication system, and a remote computing device. An exemplary remote computing device comprises a biometric system and a GPS system for verifying that the correct employee is working at the correct job site. For example, if an employee attempts to “clock-in” or “clock-out” at a job site where he is not scheduled to be working, he will not be able to clock-in or out.

### BRIEF DESCRIPTION OF THE DRAWINGS

The subject matter of the invention is particularly pointed out in the concluding portion of the specification. The invention, however, both as to organization and method of operation, may best be understood by reference to the following description taken in conjunction with the accompanying drawing figures, in which like parts may be referred to by like numerals:

FIG. 1A is a block diagram, according to an exemplary embodiment of the invention, which illustrates an overview of the claimed system and method and the relationship of various system components to other system components.

FIG. 1B is a block diagram, according to another exemplary embodiment of the invention, which illustrates the claimed system and method and the relationship of various system components to other system components.

### DETAILED DESCRIPTION

The present invention may be described herein in terms of various functional components and processing steps. It should be appreciated that such components and steps may be realized by any number of hardware and/or software components configured to perform the specified functions. In addition, the present invention may be practiced in any number of computer software contexts and that the exemplary embodiments relating to a method and system for time collection and operations scheduling as described herein are merely indicative of exemplary applications for the invention. For example, the principles, features and methods discussed may be applied to any software application. Further, various aspects of the present invention may be suitably applied to other applications.

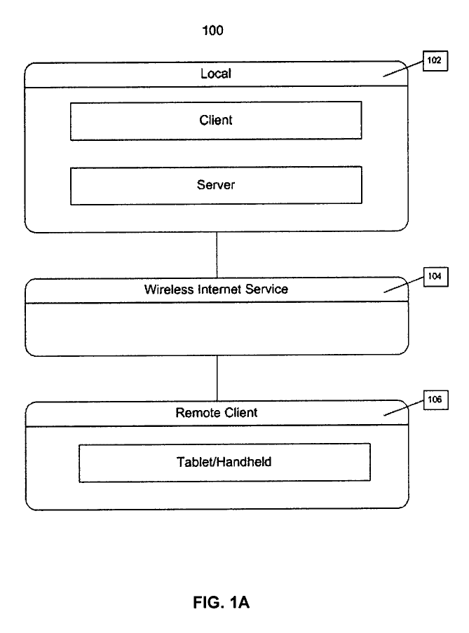

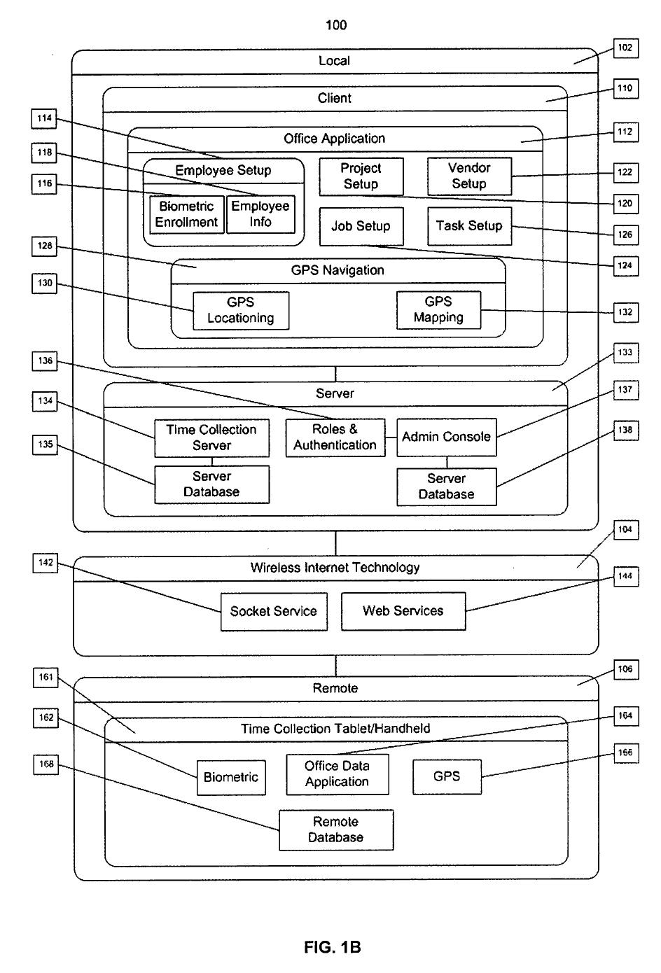

With reference to FIG. 1A, various embodiments of a remote time collection system 100 according to the present invention comprise a local system 102 and a remote system 106 that communicates with local system 102 via a communications system 104. Remote time collection system 100 comprises any system configured to verify, using biometric and/or other identification methods, that a specific employee has begun working at a specific location and/or to track the time the employee works at that location.

With reference to FIG. 1B, an exemplary local system 102 of remote time collection system 100 comprises a server 133 and a client 110 configured to communicate with server 133. Client 110, for example, a client computing device, may comprise a office application 112 that runs on client 110 in local system 102, and client 110 may be configured to communicate with server 133 also in local system 102. Local system 102 and/or client 110 may be configured to communicate with remote system 106 via a distributed smart client application, such as office data application 164. Office data application 164 and/or office application 112 may be configured to comprise “front-end” applications (“FEA”), and server 133 may be configured to comprise a “back-end” application (“BEA”).

Client 110, according to other exemplary embodiments, is configured to house office application 112. Office application 112 may be configured to comprise a smart client application such as a “rich”, “fat”, and/or “thick” client application running on client 110 that communicates with a server 133 in a distributed environment (multi-server and/or multi-client). Many different types of smart clients exist. For example, a “fat” client, or a “thick” or “rich” client, is a client computer that performs the bulk of any data processing operations itself and may or may not rely on a centralized computer or server. A “thin” client, on the other hand, typically relies on the resources of a centralized computer. A thin client generally only displays graphics communicated to it by a centralized computer, and the centralized computer does the bulk of the data processing and other computing functions. A hybrid client also exists which is a combination of a fat and a thin client.

In an exemplary embodiment of the present invention, office application 112 comprises a Windows Forms™ smart client. A smart client application is, for example, an easily deployed and managed client application that provides an adaptive, responsive and rich interactive experience by leveraging local resources and intelligently connecting to distributed data sources. Smart client applications are configured in part to help to solve functionality and speed deficiencies which resulted from converting desktop computer-based application to Internet web-based applications. Smart clients help to solve these deficiencies.

Office application 112 of client 110 comprises, according to various exemplary embodiments, an employee setup module 114, a project setup module 120, a job setup module 124, a vendor setup module 122, a task setup module 126, and/or a global positioning satellite (“GPS”) module 128. In certain embodiments, office application 112 may comprise a smart client application.

An exemplary employee setup module 114 comprises a biometric enrollment module 116 and/or an employee info module 118. Employee setup module 114 is configured to receive and process information relating to different employees. For example, an employee's name, picture, title, contact information, health and/or safety information, skill information, manager, supervisor, direct supervisor, and the like may be received and/or processed by employee info module 118. Employee info module 118 is configured to keep track of company employees and their title, department, identification, and other information for access and/or use by human resources. Biometric enrollment module 116 may be configured to receive biometrics for various employees. These biometrics may be used with other components of time collection system 100, such as biometric module 162 in remote device 106 to verify that a particular employee is working at a particular job site and/or to only allow an employee to “clock in” at a job site where the employee is scheduled to work.

Biometric enrollment module 116 may be configured with one or more biometric scanners, processors and/or systems. A biometric system may include one or more technologies, or any portion thereof, such as, for example, recognition of a biometric. As used herein, a biometric may include a user's voice, fingerprint, facial, ear, signature, vascular patterns, DNA sampling, hand geometry, sound, olfactory, keystroke/typing, iris, retinal or any other biometric relating to recognition based upon any body part, function, system, attribute and/or other characteristic, or any portion thereof. One embodiment of the invention stores, utilizing biometric enrollment module 116, a list of field personnel and their biometric identification information and verifies an employee's identity during the clock-in and clock-out processes. In an exemplary embodiment, biometric enrollment module 116 and/or remote biometric module 162 may comprise a device that meets certain specifications with the BioAPI Consortium. This group was founded to develop a biometric Application Programming Interface (API) that brings platform and device independence to application programmers and biometric service providers.

A project setup module 120 according to various embodiments of the invention is configured to receive and/or process details relating to specific projects, customers, and/or employees. For example, project setup module 120 may communicate with office data application 164 on remote system 106 to provide an employee with details about a specific project. According to another embodiment, project setup module 120 may be configured to display pertinent information about a project such as; project name, project identification, location, project start date, project supervisor, and/or detailed comments about activity of the project.

In accordance with other embodiments, a job setup module 124 is configured to receive and/or process information relating to specific jobs that an employee may be assigned. Job setup module 124 may be configured to communicate with office data application 164 on remote system 106 to provide an employee with details about a specific job. An exemplary job setup module 124 may be configured to display pertinent information about a job and its relationship to a project such as; job name, job identification, location, job start date, acting job supervisor, project relationship, and/or detailed comments about activity of the job.

Another embodiment of the invention comprises a vendor setup module 122 that is configured to receive and/or process information relating to various vendors. An exemplary vendor setup module 122 is configured to track pertinent information about specific vendors and/or subcontractors used to subcontract work for specific projects or jobs. Such information may include: vendor name, address, city, state, zip, phone numbers, contacts, and/or type of vendor (or subcontractor).

Still other embodiments comprise task setup module 126 that is configured to receive and/or process information relating to specific tasks that an employee may be required to perform. For example task setup module 126 may communicate with job setup module 124, project setup module 120 and/or vendor setup module 122 in order to aid in completion of various jobs and/or projects in connection with vendor requirements. Task setup module 126 may also be configured to communicate with office data application 164 in order to provide an employee with specific tasks related to the job site. An exemplary task setup module 126 may be configured to store pertinent information about common and/or specialized tasks used within a job such as: task name, task identification, task type, job relationship information, and/or ordering for tracking specific tasks that should be done before another task may be performed.

Further embodiments of the invention comprise GPS module 128 that comprises GPS locationing module 130 and GPS mapping module 132. An exemplary GPS module 128 is configured to be used as a plug-in for office application 112 to plot project areas for remote client locationing and to track company vehicles or equipment used in field work. GPS module 128 is configured to receive and store a location where a particular employee is scheduled to work. For example, GPS locationing module 130 may be configured to receive inputs from various modules such as project setup module 120, job setup module 124, and/or task setup module 126 in order to store information about the locations where employees are scheduled to work. GPS module 128 may be configured to receive GPS locations corresponding to where employees are attempting to clock in, for example, from remote GPS module 166 in remote system 106 via communications system 104. GPS module 128 may be configured to then compare a desired employee location to an actual employee location to determine whether or not to let the employee clock in at the actual location.

In other embodiments, for office application 112 to recognize the current remote user's GPS coordinates as a valid location, or an “on-site” location, the location must be registered with the GPS module 128. Registered locations are stored and or maintained at a central location, for example on a server 133. In other embodiments, coordinates are gathered by other means such as online mapping or other GPS systems via GPS mapping module 132. An exemplary GPS mapping module 132 is configured to allow a user on the server side to gather GPS coordinates for a certain area on a map and assign those coordinates to a project. In another embodiment, GPS mapping module 132 is configured to allow a user (e.g., management and/or supervisors) to monitor where employees and/or a crew of employees are located in the field. In yet another embodiment, GPS mapping module may allow the monitoring of employee locations by gathering current GPS coordinates for employees and/or crews and displaying those coordinates and/or the relationship of those coordinates on a map.

Turning now to server 133 of local device 102, server 133 comprises, according to various exemplary embodiments, a time collection server 134, a time collection database 135, a roles and authentication module 136, an admin console 137, and/or an admin console database 138. In another embodiment of the invention, the server comprises a BEA such as time collection Windows™ server 134. Time collection server 134 functions as a hub of communication with which the remote clients and centralized server applications, such as client 110 and remote system 106, can synchronize and display real-time data. The main user's office manager or other supervisor or administrator can see what tasks the remote users are currently performing, for example, via admin console 137, and at the same time the remote user can see what work a manager has requested them to perform, for example, via office data application 164 on remote system 106.

An exemplary time collection server 134 is configured to comprise a Windows 2003™ server, Windows XP™ server, or Window Vista™ server. The BEA uses database management software, for example Microsoft™ SQL server, to store all the various data coming in from remote computers and/or from other sources, such as from corporate intranet office computers. In other embodiments, the BEA hosts a main user's corporate services in a demilitarized zone (“DMZ”) portion of the user's network. This placement of the BEA has many advantages, for example in one embodiment this placement exposes the BEA services to the remote client computers through the Internet and exposes the BEA services to the main office computers on the corporate intranet. In an exemplary embodiment of the invention, the BEA comprises a static IP address.

According to another embodiment, time collection database 135 is configured to receive, process, and/or store information related to projects (such as name, identification, location, project start, project supervisor, etc.), vendors (such as name, full address, phone numbers, primary contacts, subcontractor type, etc.), jobs (such as name, identification, location, project relationship, job start date, acting supervisor, etc.), tasks (such as name, type, and associating job, etc.), employees (such as full name, employee identification number, picture, biometric signature, direct supervisor, title, department, etc.), and employees' time records (such as employee relation, clock in/out tracking, task and job the employee recorded time for, etc.).

A roles and authentication module 136 according to other embodiments of the present invention is configured to receive and process information related to an employee that has been setup in admin console application 137. A combination of the username and password for the user may be used to verify that the user has access to the application that they are attempting to log in to. This level of security is protected through methods of compression and/or encryption, such that the information is not human readable.

In still other embodiments, admin console application 137 and admin console database 138 are configured to handle the security configuration settings for centralized and remote usage. The administrator console application 137 provides a secure way to isolate user features and abilities contained within the graphical user interfaces (GUI) that are used in the client 110, office data application 164, centralized server 133 applications. The console provides criteria for user roles, access levels, password information, biometric information, remote location information, and other user and site-related information. A system administrator will have full control of these and other security features.

An exemplary remote system 106 of time collection system 100 comprises an employee device 161, a biometric module 162, an office data application 164, a remote GPS module 166, and/or a time collection remote database 168. Remote system 106 may be configured to communicate with local system 102 via a wireless and/or local area network (“LAN”) communications system 104, such as a system comprising a wireless Internet modem or other wireless communications device and/or medium. In an exemplary embodiment, the use of a tablet personal computer improves the remote user experience by allowing users to interact with the software by using a pen or stylus.

Employee device 161 comprises, according to various embodiments, computing devices that may be used at a remote location, e.g., at a construction job site. For example, employee device 161 may comprise a tablet PC, cellular device, laptop computer, handheld device, and/or other communication devices. An exemplary embodiment of the invention comprises a remote employee device 161 running an operating system, such as Windows XP® or Windows Vista®.

Biometric module 162, according to other embodiments of the present invention, is configured to facilitate the clocking-in and clocking-out of an employee at a job site. The biometric identification system recognizes biometric information about a remote user and allows the user to access the time card portion of the application. The user may only access the time card if the user is in a valid location for the transaction to take place, e.g., where the remote user is scheduled to work. In one embodiment of the invention, the biometric security system eliminates fraudulent time entry by requiring remote users to clock in and out using various forms of biometric identification. In various embodiments of the invention, the biometric reader security system may include a transponder and a reader communicating with the system. The biometric security system also may include a biometric sensor that detects biometric samples and a device for verifying biometric samples.

In still other embodiments, office data application 164 is configured to comprise a distributed smart client application that runs on remote employee device 161. For example, the distributed smart client may run on the Windows XP®\Windows Vista® operating system. Remote computer 161 and/or office data application 164 may be configured to comprise a thick client. This exemplary client may utilize a two stage process to get data. The first process is pulling the data from server 133 and inserting it into the remote database 168 that is found locally on the remote client, e.g., on office data application 164. The second process is pulling of the populated data on the remote client database 168. All of the processing occurs on remote computer 161; for example, the processing may be configured to occur in remote client database 168 and/or in remote client application 164.

In an exemplary embodiment, the local (non-server) computer 110 comprises a hybrid client. In certain embodiments computer 110 is not required to have a local cache of data to pull from, but rather gets it from server 133. Some of the processing occurs on local computer office application 112, and some on server database 135. The distributed smart client may be configured to give a remote user the ability to see what work he has been scheduled to perform from a central location and allows him to enter time data about a particular scheduled item.

Further embodiments of the invention provide an office data application 164 provides an interface for remote users to view scheduled tasks and clock-in and clock-out using the biometric identification system. Office data application 164 acquires job site, task and/or project information from local system 102, for example, via the wireless Internet connection and web services in communication system 104.

Remote GPS module 166, in accordance with further embodiments, is configured to enable remote system 106 and/or office data application 164 to restrict clocking functionality to a specific region. For example, a remote user will not have the ability to clock-in unless the remote computer is located within the coordinate range specified by office application 112. Remote GPS coordinates are gathered and are stored in the server database 135 that holds project coordinates such as project identification, north/south latitude, and/or east/west longitude. This data is may also be confirmed within GPS location module 130. This functionality aids in confirming that the correct field worker is performing the scheduled task at the specified job site.

An exemplary time collection remote database 168 is configured to receive, process and/or store time data for various employees and/or workers. Time collection remote database 168 may comprise a Microsoft SQL Server Express database. The remote computer 161 utilizes a database server, for example a Microsoft SQL Server, for data storage on both the remote computer, or client, and the centralized computer, or server. An exemplary embodiment of the invention provides a location determination and/or verification device, such as a GPS device. The location device allows the enabling or disabling of clocking features based on the validity of the current GPS coordinates of the remote computer running the FEA. In addition to biometric verification, requiring the remote computer, such as a tablet pc, to be located at a job site through the use of location determination and/or verification adds an additional level of protection against fraudulent time entry.

An exemplary communications system 104 of time collection system 100 comprises a socket service module 142 which provides a stand alone raw communication service for remote clients to send and receive data in the field and/or a web services module 144. In another exemplary embodiment of the invention, time collection system 100 uses wireless communication technology, for example wireless Internet services, wireless telecommunications services, satellite communication services, remote socket and the like, to communicate the data and handle messaging to and/or from the remote system 106 and local system 102, e.g., the front end and back end server services. In an exemplary embodiment of the invention, a wireless Internet connection is used to communicate the data, for example, via web services module 144. Web services describes a standardized way of integrating Web-based applications using the XML, SOAP, WSDL, and UDDI open standards over an Internet protocol backbone. XML is used to tag the data, SOAP is used to transfer the data, WSDL is used for describing the services available and UDDI is used for listing what services are available. Used primarily as a means for businesses to communicate with each other and with clients, Web services allow organizations to communicate data without intimate knowledge of each other's IT systems.

In other embodiments of the invention, the communications between local system 102 and remote system 106 are compressed and encrypted. Many types of compression and encryption technology are well-known in the art. One such encryption method is used to encrypt the transfer of data to and from remote system 106. A user is verified during this process and appropriate access is granted or denied.

Another embodiment of the invention provides a communications system, such as a wireless and/or LAN communications system, for example a system comprising a wireless Internet modem and a wireless Internet connection. The communications system provides a means for real-time data collaboration between field and office personnel. A wireless communications system facilitates such communications even though the distances between field and office may prohibit tradition LAN communication. Various embodiments of the present invention utilize a wireless Internet modem and a wireless Internet service to transfer data between the FEA and BEA, for example, via custom web services in web services module 144.

Socket service module 142, according to an exemplary embodiment, is configured to process various commands from a remote client including methods for authentication and data access. The socket service module exists as a stand alone alternative to traditional web services providing the same functionality without dependency on foreign technology.

In accordance with another embodiment of the present invention, web services module 144 is configured to integrate with a main user's server, e.g., time collection windows server 134 and tie into an existing intranet. This integration is accomplished in one embodiment by the use of an API (Application Programming Interface) or an OAP (Open Architecture Pipeline) framework. The API is accessible through dynamic link library (dll) assemblies and direct communication to the web services from the main user's server. By providing this API and open architecture to the main user this embodiment provides time and scheduling data to a remote user.

A further embodiment of the invention provides a field scheduling module. The field scheduling module comprises a module within the BEA that handles the scheduling of items that a remote user will see in the remote client application. The scheduling module allows a centralized administrator to schedule a job for a particular job-site and for a specific remote user and/or set of remote users. It gives managers, administrators, and/or supervisors the ability to customize a specific task and its steps for completion so that a remote user can refer to the process while performing his duties. In other embodiments, the field scheduling module provides functionality where other administrative tasks can be performed, for example, viewing hours for a certain remote user and/or set of remote users and the tasks the users have performed. The module provides the ability to edit hours and/or view comments from the remote users regarding a specific task.

Another exemplary embodiment of the invention provides a job monitoring module. The Job Monitoring module is an informative tool for the remote user which allows the worker to view pertinent information about a job site and the worker's overall duties. Through the job monitoring module remote users can, for example, view reporting metrics regarding task completion, view administrative comments, ask for administrative assistance, and manage crew responsibilities.

The present invention may be described herein in terms of various functional components and processing steps. It should be appreciated that such components and steps may be realized by any number of hardware and/or software components configured to perform the specified functions. In addition, the present invention may be practiced in any number of software contexts and that the exemplary embodiments relating to a system as described herein are merely indicative of exemplary applications for the invention. For example, the principles, features and methods discussed may be applied to any software application. Further, various aspects of the present invention may be suitably applied to other applications, such as other software or computer applications.

1. A system for automatically collecting a work time of a user at a job site, comprising:
a local system, comprising a database configured to contain a reference biometric datum and a reference location datum;
a remote system, comprising a biometric device configured to receive a user biometric datum from the user, and a location device configured to receive a user location datum from the job site; and
a communications system for transmitting the user biometric datum and the user location datum from the remote system to the local system;
wherein, the local system compares the reference biometric datum with the reference location datum in order to automatically collect the work time from the user at the job site.

2. A system according to claim 1, wherein the local system further comprises a client and a server.

3. A system according to claim 2, wherein the client further comprises at an office application module, an employee setup module, a project setup module, a vendor setup module, a job setup module, and a task setup module.

4. A system according to claim 2, wherein the client further comprises a locationing module and a mapping module.

5. A system according to claim 2, wherein the server comprises a time collection server, a server database, a roles and authentication module, an admin console, and an admin console database.

6. A system according to claim 1, wherein the communications system comprises at least one of a socket service and a web service.

7. A system according to claim 1, wherein the remote system further comprises an office data application and a remote database.

8. A system according to claim 2, wherein the client comprises a thick client.

9. A system according to claim 1, wherein the reference biometric datum comprises a fingerprint.

10. A computer-implemented method for monitoring activity of a user at a site, the method comprising:
creating a database, the database comprising a user biometric field and a user location field;
modifying the database at a back-end computer, wherein the back-end computer communicates with a server;
assigning a set of user values to the database;
storing the database on the server;
receiving, at a remote computer, a user biometric and a user location;
communicating the user biometric and the user location between the remote computer and the back-end computer;
comparing the user biometric and the user location with the first set of user values;
if the user biometric and the user location correspond correctly to the first set of user values, recording at a user start time and communicating a job description to the user;
receiving, at the remote computer, a job completion status;
communicating, between the remote computer and the back-end computer a user finish time and the job completion status.

11. A method according to claim 10, wherein the database further comprises a user field, a site location field, a job description field, and a time collection field.

12. A method according to claim 10, further comprising the steps of:
storing, in the database, a remote computer site location;
receiving an actual remote computer location;
verifying that the actual remote computer location corresponds to the remote computer site location; and
allowing the user to access the remote computer.

13. A method according to claim 10, further comprising the steps of:
receiving, at the back-end computer, a location of a vehicle; and
tracking the location of the vehicle.

14. A method according to claim 10, wherein the communicating steps comprise the step of communicating using at least one of a wireless network, a local area network, an Internet network, an intranet network, a socket service, and a web service.

15. A method according to claim 10, wherein the comparing step is performed using the back-end computer, the remote computer, or a combination of the back-end and remote computers.

16. A method according to claim 10, wherein the communicating steps further comprise the step of compressing and encrypting the user biometric and the user location.

17. A system for remotely monitoring a user work time at a work site comprising:
a back-end computer, the back-end computer comprising:
a user database;
a manager interface; and
a communications device; and
a front-end computer, the front-end computer comprising:
a biometric device;
a location determination device; and
a communications device for communicating with the back-end computer.

18. A system according to claim 17, wherein the back-end computer further comprises a demilitarized zone.

19. A system according to claim 17, wherein the location determination device comprises a GPS device.

20. A machine-readable medium having stored thereon a plurality of instructions for monitoring a user at a site and providing a job description to the user, the plurality of instructions, when executed by a processor, causing the processor to:
determine a biometric of the user;
verify that the biometric of the user matches a stored user biometric;
determine a location of the user;
verify the location of the user matches a stored user location; and
upon verification that the location of the user matches the stored user location and that the biometric of the user matches the stored user biometric:
record a user start time;
provide a job description to the user;
receive, from the user, a job status report; and
receive, from the user, a user finish time.
